(19) United States
(12) Patent Application Publication
(10) Pub. No.: US 2006/0186753 A1
(43) Pub. Date: Aug. 24, 2006

(54) Stator and electric motor having the same

(75) Inventors: Kyoung Soo Yang, Suwon (KR); Moon Kyu Han, Seoul (KR)

Correspondence Address: LOWE HAUPTMAN BERNER, LLP, 1700 DIAGONAL ROAD, SUITE 300, ALEXANDRIA, VA, 22314, US

(73) Assignee: Samsung Electro-Mechanics Co., Ltd., Suwon (KR)

(21) Appl. No.: 11/274,406

(22) Filed: Nov. 16, 2005

(30) Foreign Application Priority Data
Feb. 21, 2005 (KR) 10-2005-13988

(51) Int. Cl. H02K 1/00; H02K 3/46

(52) U.S. Cl. 310/216; 310/260

(57) ABSTRACT

The present invention provides a stator including a core having a plurality of core plates piled on one another, and a plurality of teeth formed in a regular interval on the circumference of the core. The stator also has a plurality of protuberant parts bent upward from outside to inside on one of the plurality of core plates. The stator further has at least one coil having winding parts wound on the teeth of the core and connecting parts hitched on the protuberant parts. The present invention allows simpler bending process of the core, with fewer molds, thus reducing the manufacture cost and the manufacture time to enhance productivity.

### CLAIM OF PRIORITY

This application claims the benefit of Korean Patent Application No. 2005-13988 filed on Feb. 21, 2005, in the Korean Intellectual Property Office, the disclosure of which is incorporated herein by reference.

### BACKGROUND OF THE INVENTION

1. Field of the Invention

The present invention relates to a stator and an electric motor having the same, and more particularly, to a stator and an electric motor having the same in which the bending process of a core is simpler with a reduced number of molds for bending the core, reducing the manufacturing costs and time to increase productivity.

2. Description of the Related Art

In general, an electric motor (hereinafter referred to as “motor”) is an apparatus for converting electric energy into mechanical energy. The motor can be categorized into many different kinds depending on the type of power, the method of activation, the type of rotor, and the type of external structure such as frame and bracket. The motor can further be broken down depending on the method of insulation, the type of bearing, output power, rotation speed, supply voltage, or frequency.

The motor with such diversity can be broadly categorized into a direct current or an alternating current motor according to the type of power applied to the motor. Further, depending on the provision of a brush which supplies the current alternately, a direct current motor can be categorized into a brush DC motor, or a brushless DC motor with no mechanical contact of the brush.

In addition, the brushless motor can be broken down into a core type (or radial type) of a cup structure, and a coreless type (or axial type), depending on the provision of a stator core.

The core type motor can further be divided into the following two types: an inner rotor type having a stator with a coil wound on the core extended toward the inner circumference, and a rotor with a cylindrical permanent magnet disposed in the inner center of the stator to rotate the internally disposed rotor; and an outer rotor type having a stator with a coil wound on the core extended toward the outer circumference, and a rotor with an annular permanent magnet outside of the stator to rotate the externally disposed rotor.

In the meantime, in the inner rotor type motor, as a coil is wound on a plurality of teeth provided in the stator core, connecting parts are needed to connect the teeth.

For example, in a three-phase motor of an inner rotor type having a rotor in the inner center of the stator with nine teeth, the U-phase coil is wound on the first, fourth, and seventh teeth, and the V-phase coil is wound on the second, fifth, and eighth teeth, and the W-phase coil is wound on the third, sixth, and ninth teeth. In other words, the coil finished winding on one tooth is wound on another one disposed two teeth apart.

Therefore, the part of the coil from a finishing point of the winding at one tooth to a starting point of the winding at another tooth is called a connecting part. If this connecting part of the coil bridges directly from a tooth to another, the winding procedure of the coil is hindered, causing disconnection, etc. Therefore, securing sections must be provided on the core to secure the connecting parts of the coil from one tooth to another.

As shown in FIG. 7, a conventional stator 10 having such securing sections includes a core 10a having a plurality of core plates 14 piled up on one another, with a plurality of teeth 13 protruded in a regular interval toward the inner circumference, a synthetic resin ring 19 on the uppermost layer of core plate 14, having securing sections 19a protruding upward and alternating with the teeth 13, with the upper end of each securing section 19a bent toward outside. Therefore, the connecting part 12b, which connects the winding parts 12a of the coil wound on the teeth, is hitched and secured on the securing section 19a.

However, the above construction of the conventional stator core 10a requires additional installation of the synthetic resin ring 19 on the uppermost part of the core plates 14, with so many assembly components and complicated assembly steps, increasing the manufacturing costs and undermining the miniaturization of the motor.

Japanese Laid-open Application No. 2004-242405 discloses a stator core having an annular core back and a plurality of teeth formed by piling up a plurality of metal core plates on one another. As shown in FIG. 8, the core plate 22 piled on the uppermost part of the stator core 20 has securing sections 22a, which are bent perpendicularly upward from inside, and then bent horizontally toward outside, so that the securing sections 22a do not protrude outside of the core plate 21, 22.

However, as shown in FIG. 5b, the above described securing sections 22a provided on the conventional stator core 20 has a metal-processed, horizontal incision part which is bent perpendicularly on the uppermost part of the core plates 22 in a first step, and bent substantially horizontally in a second step, and then completed in a third step to be parallel to the upper part of the core plate 22. This process requires complicated bending procedures of the securing section 20b, resulting in a prolonged manufacturing time, and thus lower productivity, and requiring so many molds to increase the manufacturing costs.

### SUMMARY OF THE INVENTION

The present invention has been made to solve the foregoing problems of the prior art and it is therefore an object of the present invention to provide a stator and an electric motor having the same which require simple bending process and fewer molds to reduce the manufacturing costs and manufacturing time to enhance productivity.

In order to realize the above described object, the present invention provides a stator including: a core having a plurality of core plates piled up in a thickness direction on one another; a plurality of teeth each extended in a regular interval from the inner circumferential surface of the core; a plurality of protuberant parts bent upward from outside to inside on one of the plurality of core plates; and at least one coil having winding parts wound on the teeth of the core, and connecting parts hitched on the protuberant parts disposed between the teeth to connect the winding parts of the coil.

Preferably, each of the protuberant parts has a distal end bent toward the outer circumference, forming a second bent part.

Preferably, each of the protuberant parts is slanted by a predetermined angle toward the inner circumference about a normal axis perpendicularly meeting the surface of the core plate.

Preferably, each of the protuberant parts has the distal end positioned within the outer circumference of the core.

Preferably, the stator has a recess provided in a depth substantially greater than the thickness of the coil, on the outer surface of the core plate corresponding to the protuberant part.

Preferably, the stator has a magnetic flux reinforcement part extended toward the inner circumference in a predetermined length from the inner side of the core plate corresponding to the protuberant part.

Moreover, the present invention provides an electric motor including: a stator having a core having a plurality of core plates piled up in a thickness direction on one another, a plurality of teeth each extended in a regular interval from the inner circumference of the core, a plurality of protuberant parts bent upward from outside to inside on one outer circumferential surface of the plurality of core plates, and at least one coil having winding parts each wound on the teeth of the core and connecting parts hitched on the protuberant parts disposed between the teeth to connect the winding parts of the coil; a rotor having a magnet in the inner side facing the core; and a shaft part rotatably provided between the stator and the rotor about the stator.

Preferably, each of the protuberant parts has a distal end bent upward toward the outer circumference, forming a second bent part.

Preferably, each of the protuberant parts is slanted by a predetermined angle toward the outer circumference about a normal axis perpendicularly meeting the surface of the core plate.

Preferably, each of the protuberant parts has the distal end positioned within the outer circumference of the core.

Preferably, the electric motor has a recess provided in a depth substantially greater than the thickness of the coil, on the outer surface of the core plate corresponding to the protuberant part.

Preferably, the electric motor has a magnetic flux reinforcement part protruding toward the inner circumference in a predetermined length in the inner side of the core plates.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a detailed view illustrating a core provided in a stator according to the present invention;

FIG. 2 is a detailed view illustrating the stator according to the present invention;

FIG. 3 is a detailed view illustrating a part of the core provided in the stator according to the present invention;

FIGS. 4 (a), (b), and (c) are detailed views illustrating a part of protuberant part provided in the stator according to another embodiment of the present invention;

FIG. 5a is a schematic view illustrating the bending process of the protuberant part provided in the stator according to the present invention;

FIG. 5b is a schematic view illustrating the bending process of the securing section provided in a conventional stator;

FIG. 6 is a longitudinal sectional view illustrating an electric motor having the stator according to the present invention;

FIG. 7a is a plan view illustrating the conventional stator;

FIG. 7b is a sectional view illustrating the conventional stator; and

FIG. 8 is a detailed view illustrating the securing section provided in the conventional stator.

### DETAILED DESCRIPTION OF THE PREFERRED EMBODIMENT

Preferred embodiments of the present invention will now be described in detail with reference to the accompanying drawings.

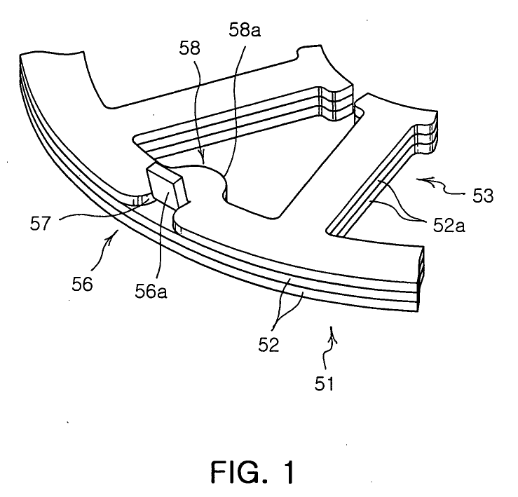

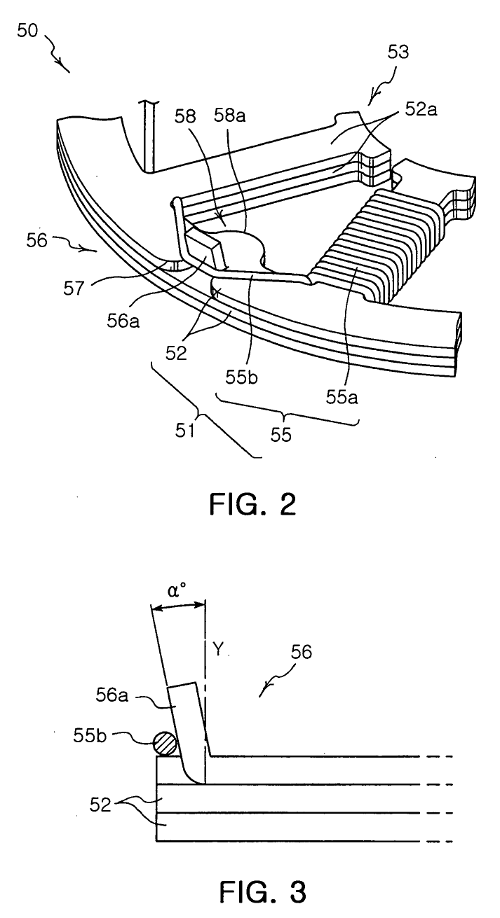

FIG. 1 is a detailed view of a core provided in a stator according to the present invention, and FIG. 2 is a detailed view of the stator according to the present invention.

As shown in FIGS. 1 and 2, the stator of the present invention 50 includes an annular core 51 and at least one coil 55 wound on the same.

The core 51 is formed with a plurality of core plates 52, which are thin metal plates cut and processed in an annular shape, piled up in a thickness direction Y on one another in at least two layers.

In the inner side of each core plate constituting the core 51, a plurality of protrusion parts 52a, each extending in a predetermined length toward the inner circumference, are provided in a regular interval on the circumference of the core 51. With this configuration, a plurality of teeth 53 forming winding parts 55a with the coil 55 wound for a number of times thereon are provided in the inner side of the core 51 having the core plates 52 piled up on one another.

In addition, the coil is wound on the teeth 53 of the core 51 for a number of times to form winding parts 55a formed with a plurality of core plates 52 piled up on one another. Further, the coil of the winding parts 55a wound on the teeth 53 provides a continuous line without disconnection, with the connecting parts 55b serving as medium of the coil connecting the winding parts 55a wound on the teeth.

Moreover, a plurality of incision parts 56a are provided by outwardly cutting open one outer circumference of the plurality of core plates 52 piled up on one another in a thickness direction to constitute the core 51.

The incision part 56a is bent upward from outside to inside to have a distal end positioned higher than the uppermost layer of the core plates 52, thus forming a protuberant part 56 with the connecting part 55b, which connects the winding parts 55a wound with the coil on each tooth 53, is hitched and secured thereon.

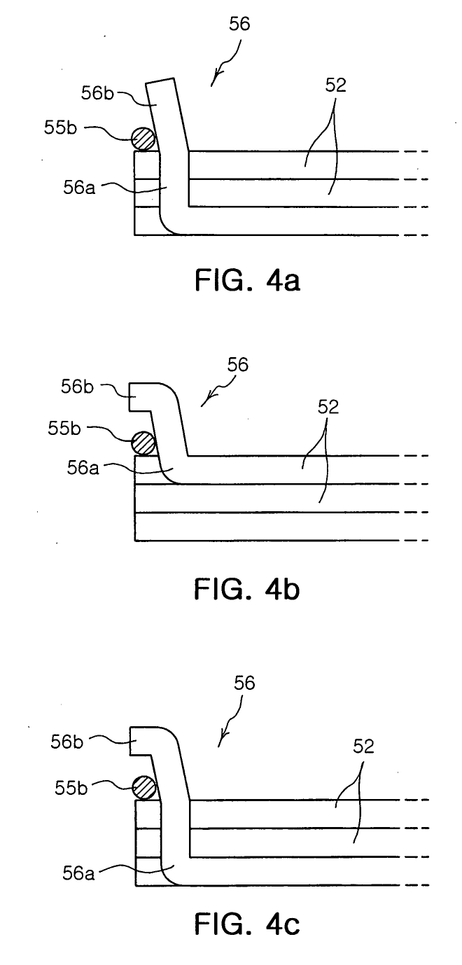

As shown in FIGS. 2 and 3, this protuberant part 56 may be formed by bending the incision part 56a, formed on the uppermost layer of the core plates 52 constituting the core 51, upward from outside to inside, but is not limited to such.

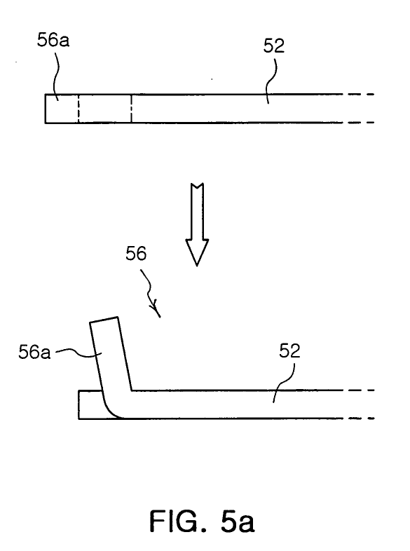

As shown in FIG. 4(a), the protuberant part 56 may be provided on the lowermost layer of the core plates 52, but may also be provided optionally on one of the core plates 52 piled in between the uppermost layer and the lowermost layer.

Moreover, the protuberant part 56 may preferably have a distal end bent toward the outer circumference, forming a second bent part 56b. In this case, the connecting part 55b can be prevented from going over the upper end of the protuberant part 56a to be derailed, which allows easier coil winding procedure, thereby preventing the derailment of the connecting part 55b as much as possible even after the winding procedure is completed.

In the meantime, as shown in FIGS. 4(b) and (c), the second bent part 56b of the protuberant part 56 is formed in parallel to the core plates 52, with the part where the bending starts forming a curve.

Further, the protuberant part 56 may be provided in parallel with a normal axis Y perpendicularly meeting the surface of the core plates, but as shown in FIG. 3, may also be provided slanted toward the outer circumference by a predetermined angle α about the normal axis Y. In this case, the connecting part 55b can be prevented from derailment by going over the upper end of the protuberant part 56a, allowing easier coil winding procedure, thereby preventing the derailment of the connecting part 55b as much as possible even after the coil winding procedure is completed.

Alternatively, the protuberant part 56 may be slanted toward the inner circumference by a predetermined angle about the normal axis Y, and the degree of the slant may preferably be in the range from 0 degrees to 90 degrees to prevent the derailment of the connecting part 55b.

In addition, it is preferable that a recess 57 having a depth substantially greater than the thickness of the passing coil is provided on the outer surface of the core plate 52 corresponding to the protuberant part 56. In this case, the protuberant part 56 is positioned in the recess 57 such that the protuberant part 56 does not protrude from the outer circumference of the core, preventing the enlargement of the exterior of the core 51 to result in the enlargement of the volume of the stator 50, thus accommodating the miniaturization of the motor.

Moreover, it is preferable that the protuberant part 56 has the distal end bent toward the outer circumference of the core plates 52, positioned within the outer circumference of the core 51.

As shown in FIGS. 1 and 2, a protrusion part 58a protruding toward the inner circumference in a predetermined length, is formed on the inner side of the core plates 52 corresponding to the protuberant part 56 to provide a magnetic flux reinforcement part 58 in the inner side of the core 51. In this case, the amount of the magnetic flux passage narrowed by the protuberant part 56 may be compensated, enabling the magnetic flux, generated by the teeth of the core during the operation of the motor, to flow easily via the magnetic flux reinforcement part 58, thereby enhancing the operational characteristics of the motor.

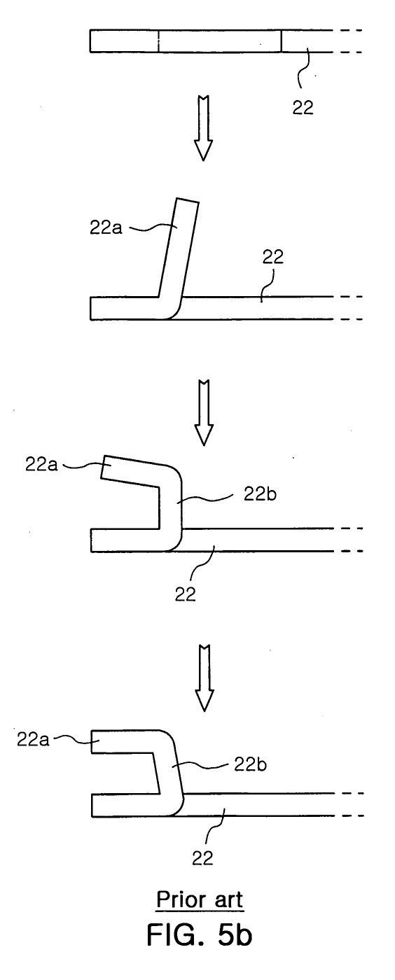

On the other hand, FIG. 5a illustrates the bending procedure of the protuberant part provided in the stator according to the present invention. As illustrated, an incision part 56a is formed by radially slitting in the outer side of the thin core plates 52. Then, in a step of bending the distal end of the incision part 56a upward, the protuberant part 56 is formed to have the connecting part 55b of the coil 55 hitched and secured thereon.

The above described bending procedure of the protuberant part 56 is simpler in procedure, fewer in the number of molds than the conventional bending procedure, thereby reducing the costs of manufacturing the core 51. As shown in FIG. 5b, the conventional bending procedure includes a first bending step in which the horizontal incision part 22a, formed by slitting the uppermost layer of the core plates 22, is bent perpendicularly, a second bending step in which the incision part 22a is outwardly and horizontally bent leaving the perpendicular part, and a third bending step in which the incision part 22a is bent to be parallel to the upper surface of the core plates 22.

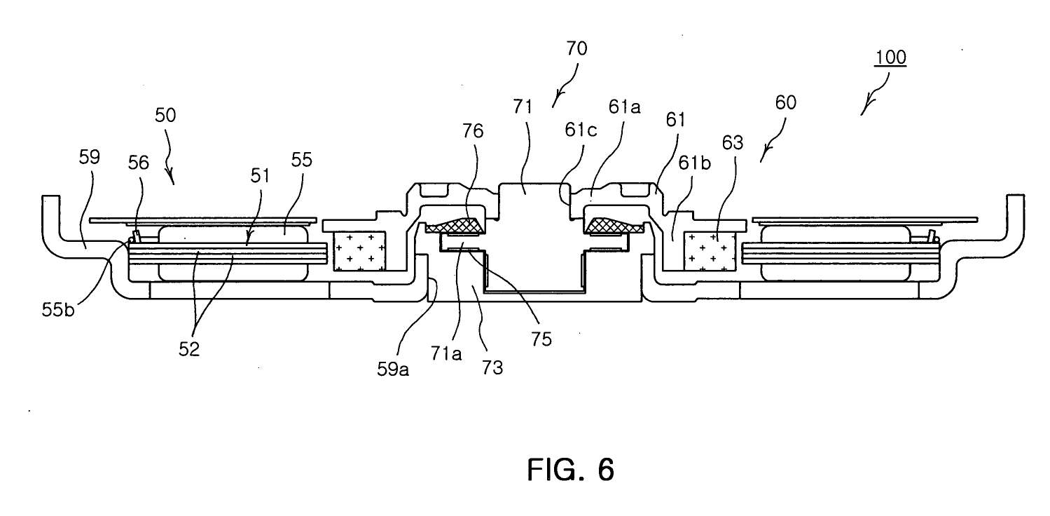

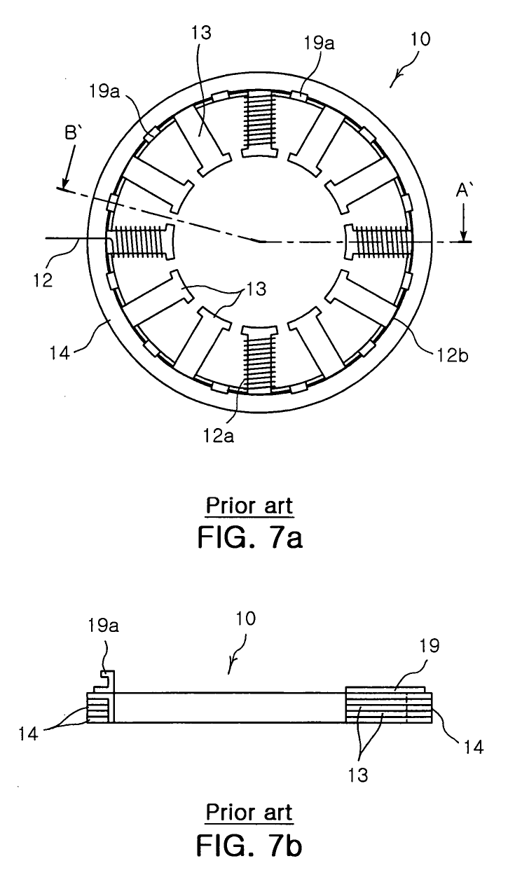

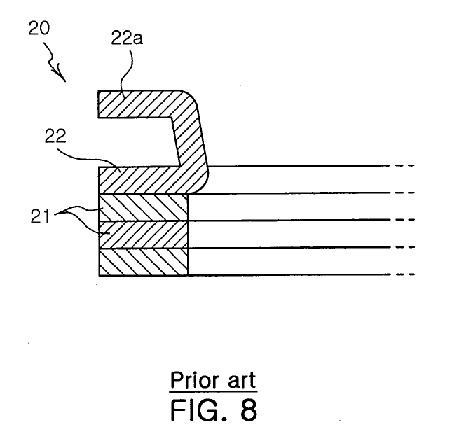

FIG. 6 is a longitudinal sectional view illustrating an electric motor having the stator according to the present invention. As shown, the electric motor of the present invention 100 includes a stator 50, a rotor 60, and a shaft part 70.

The stator 50 is a stationary structure, disposed outside of the rotor 60, including a core 51 having a plurality of core plates 52 piled up on one another, a coil wound at each of a plurality of teeth 53 disposed in the inner side of the core 51, and a stationary base 59 with the core 51 fixed therein and a sleeve 73 of the shaft part 70 installed therein.

In addition, the connecting part 55b connecting the winding parts 55a of the coil wound on each tooth 53, is hitched on the protuberant part 56 bent upward from outside to inside on one of the outer circumferential surface of the plurality of core plates, so as to prevent disconnection and remove hindrance to the coil winding procedure.

Moreover, the stationary base 59 has the shaft part 70 fixed to the center thereof into a fixing hole 59a, and the core 51 is fixed in its position with its outer circumferential surface in contact with the inner surface of the stationary base 59.

The rotor 60 is a rotary structure rotatably disposed in the inner hole of the core 51, including a hub 61 and a magnet 63.

In addition, the hub 61 includes a boss unit 61a in which the shaft 71 of the shaft part 70 is inserted and fastened into the shaft hole 61c perforated in the center of the body of the shaft part 70, and a skirt unit 61b with a magnet 63 on the outer side corresponding to the inner circumferential surface of the core 51.

The shaft part 70 is a shaft-supporting structure disposed between the stator 50 and the rotor 60, supporting the rotor 60 to be rotatable about the stator 50 when the motor is driven by the applied power.

The shaft part 70 includes the shaft 71 which is the rotation axis of the rotor 60, the cylindrical sleeve 73 with the stationary base 59 fixed into the fixing hole 59a, and with the shaft rotatably assembled thereinto, and a bearing part 75 provided on the boundary between the shaft 71 and the sleeve 73.

As shown in FIG. 6, the bearing part 75 may, but not limited to, have at least one hydrodynamic groove filled with injection air or fluid such as oil in the outer surface of the shaft 71 or the inner surface of the sleeve 73, in a form of herringbone or spiral, to generate hydrodynamic pressure between the inner surface of the stationary member of sleeve 73 and the outer surface of the shaft 71.

The bearing part 75 can be provided with bearing member such as roller bearing or ball bearing having inner and outer rings to rotatably support the rotary member of shaft 71 on the stationary member of the sleeve 73.

In addition, a stopper ring 76 is provided on the upper end of the sleeve 73, with the lower surface in contact with the upper surface of a flange part 71a extending from the shaft 71 to the outer circumference of the core 51, so as to prevent the derailment of the shaft.

The present invention set forth above includes protuberant parts provided between the teeth with the coil wound thereon, bent upward from outside to inside on one circumferential surface of the plurality of core plates piled up in a thickness direction. Therefore, the present invention provides simpler bending procedures and structure in which the connecting parts are hitched on the protuberant parts to connect the winding parts of the teeth, reducing the molds for bending and the manufacturing time, thus enhancing productivity.

While the present invention has been shown and described in connection with the preferred embodiments, it will be apparent to those skilled in the art that modifications and variations can be made without departing from the spirit and scope of the invention as defined by the appended claims.

What is claimed is:

1. A stator comprising:
a core having a plurality of core plates piled up in a thickness direction on one another;
a plurality of teeth each extended in a regular interval from the inner circumferential surface of the core;
a plurality of protuberant parts bent upward from outside to inside of the outer circumference of one of the plurality of core plates; and
at least one coil having winding parts wound on the teeth of the core and connecting parts hitched on the protuberant parts disposed between the teeth to connect the winding parts of the coil.

2. The stator according to claim 1, wherein each of the protuberant parts has a distal end part, bent toward the outer circumference, forming a second bent part.

3. The stator according to claim 1, wherein each of the protuberant parts is slanted by a predetermined angle toward the outer circumference about a normal axis perpendicularly meeting the surface of the core plates.

4. The stator according to claim 1, wherein each of the protuberant parts is slanted by a predetermined angle toward the inner circumference about a normal axis perpendicularly meeting the surface of the core plates.

5. The stator according to claim 1, wherein each of the protuberant parts has a distal end positioned within the outer circumference of the core.

6. The stator according to claim 1, further comprising a recess provided in a depth substantially greater than the thickness of the coil, on the outer surface of the core plate corresponding to the protuberant part.

7. The stator according to claim 1, further comprising a magnetic flux reinforcement part extended toward the inner circumference in a predetermined length from the inner side of the core plate corresponding to the protuberant part.

8. An electric motor comprising:
a stator having a core having a plurality of core plates piled up in a thickness direction on one another, a plurality of teeth each extended in a regular interval from the inner circumference of the core, a plurality of protuberant parts bent from outside to inside on one outer circumference of the plurality of core plates, and at least one coil having winding parts each wound on the teeth of the core and connecting parts hitched on the protuberant parts disposed between the teeth to connect the winding parts of the coil;
a rotor having a magnet in the inner side facing the core; and
a shaft part rotatably provided between the stator and the rotor about the stator.

9. The electric motor according to claim 8, wherein each of the protuberant parts has a distal end bent toward the outer circumference, forming a second bent part.

10. The electric motor according to claim 8, wherein each of the protuberant parts is slanted by a predetermined angle toward the outer circumference about a normal axis perpendicularly meeting the surface of the core plates.

11. The electric motor according to claim 8, wherein each of the protuberant parts is slanted by a predetermined angle toward the inner circumference about a normal axis perpendicularly meeting the surface of the core plates.

12. The electric motor according to claim 8, wherein each of the protuberant parts has a distal end positioned within the outer circumference of the core.

13. The electric motor according to claim 8, further comprising a recess provided in a depth substantially greater than the thickness of the coil, on the outer surface of the core plate corresponding to the protuberant part.

14. The electric motor according to claim 8, further comprising a magnetic flux reinforcement part protruding toward the inner circumference in a predetermined length in the inner side of the core plates.
